(19) United States
(12) Patent Application Publication
(10) Pub. No.: US 2016/0010675 A1
(43) Pub. Date: Jan. 14, 2016

(54) CONNECTION DEVICE FOR TUBES

(71) Applicant: MAXPLUS INDUSTRIES CO., LTD, Shanghai (CN)

(72) Inventor: Chin-Chiung CHU, Shanghai (CN)

(73) Assignee: MAXPLUS INDUSTRIES CO., LTD

(21) Appl. No.: 14/514,208

(22) Filed: Oct. 14, 2014

Related U.S. Application Data
(63) Continuation of application No. PCT/CN2014/082033, filed on Jul. 11, 2014.

(51) Int. Cl. F16B 7/18; A47B 47/00

(52) U.S. Cl. CPC F16B 7/182; A47B 47/00

(57) ABSTRACT

A connection device has a main block, two pushing blocks and two fasteners. The main block has a trapezoid cross section to form two inclined surfaces, a long side and a short side, two inner threads are formed in the main block and extending to one of the long side and the short side. The pushing blocks are attached respectively to the inclined surfaces, and each pushing block has a body, an inclined surface and two resilient tongues. The resilient tongues are formed on the body, and each resilient tongue has a free end and an engaging protrusion formed on and protruding from the free end of the resilient tongue. The fasteners are inserted into the main block, and each fastener has a thread screwed with one of the inner threads in the main block.

### BACKGROUND OF THE INVENTION

1. Field of the Invention

The present invention relates to a connection device, and more particularly to a connection device for connecting two tubes firmly.

2. Description of Related Art

Assembled cloth hangers, shoe racks or coat stands are usually composed of metal tubes, and the tubes may be round, trapezoid or rectangular in section. To connect two tubes, a bushing is securely mounted on one end of one of the tube by a welding process, and the other tube is mounted around the bushing to connect the tubes by the bushing. However, the conventional way of connecting two tubes with bushing is not stable and firm. A welding process is necessary for mounting the bushing on the tube, such that the conventional way is time-consuming and costly.

To overcome the shortcomings, the present invention tends to provide a connection device to mitigate or obviate the aforementioned problems.

### SUMMARY OF THE INVENTION

The main objective of the invention is to provide a connection device to connect two tubes easily, firmly and stably.

The connection device has a main block, two pushing blocks and two fasteners.

The main block has a trapezoid cross section to form two inclined surfaces, a long side and a short side, two inner threads formed in the main block and extending to one of the long side and the short side. The pushing blocks are attached respectively to the inclined surfaces of the main block, and each pushing block has a body, an inclined surface and two resilient tongues. The inclined surface and the outer surface are respectively formed at two sides of the body. The resilient tongues are formed on the body, and each resilient tongue has a free end and an engaging protrusion formed on and protruding from the free end of the resilient tongue. The fasteners are inserted into the main block, and each fastener has a thread screwed with one of the inner threads in the main block.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a connection device in accordance with the present invention;

FIG. 2 is an exploded perspective view of two tubes and the connection device in FIG. 1;

FIG. 3 is an operational exploded perspective view of the tubes and the connection device in FIG. 2;

FIG. 4 is an enlarged operational top view of the tubes and the connection device in FIG. 3; and

FIG. 5 is an exploded operational perspective view of a coat stand composed of tubes connected with each other by the connection devices in FIG. 1.

### DETAILED DESCRIPTION OF PREFERRED EMBODIMENT

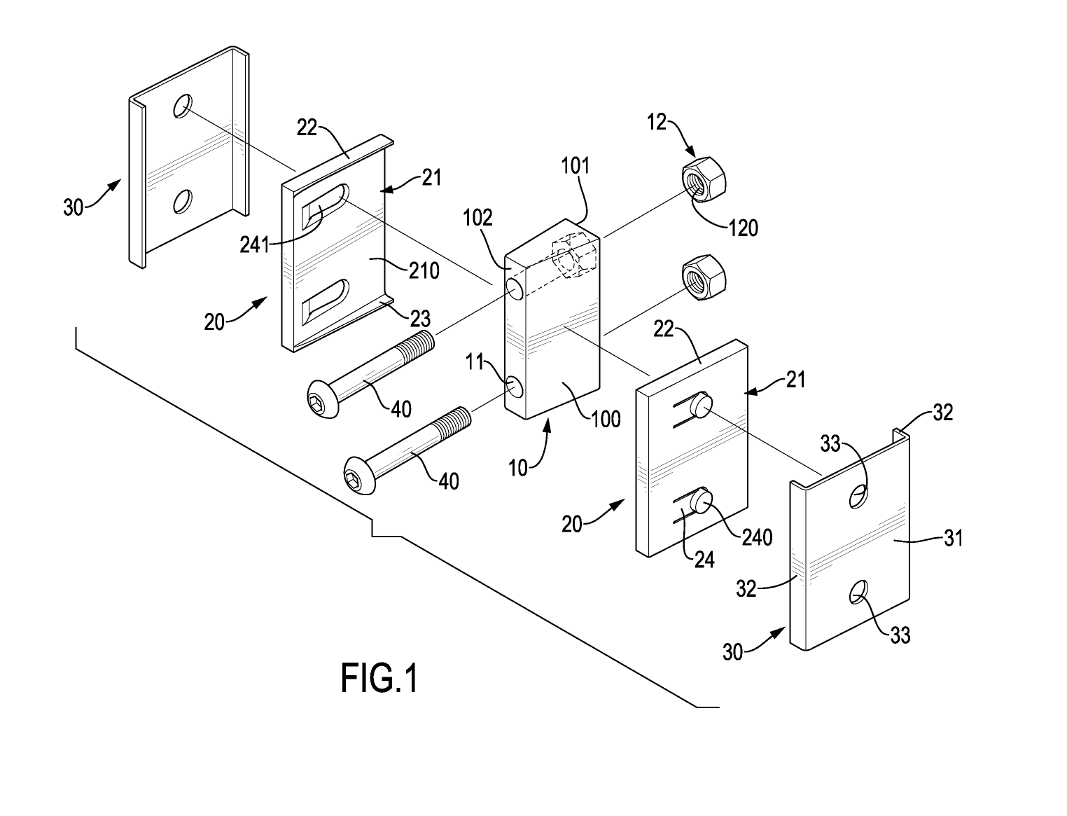

With reference to FIG. 1, a connection device in accordance with the present invention comprises a main block 10, two pushing blocks 20, two holding elements 30 and two fasteners 40.

The main block 10 has a trapezoid cross section to form two inclined surfaces 100, a long side 101 and a short side 102. Two through holes 11 are defined in the short side 102, and two inner threads 120 are formed in the long side 102 and communicate respectively with the through hole 11. In the present embodiment, the main block 10 has two hexagonal nut holes defined in the long side 102 of the main block 10. Two hexagonal nuts 12 are mounted respectively in the nut holes, and the inner threads 120 are formed respectively in the nuts 12. The nuts 12 can be embedded in the main block 10, or can be integrally formed in the main block 10 as a single piece. Alternatively, the inner threads 120 can be formed in the main block 10 directly. The way of forming the inner threads 120 is not limited in the present invention. The fasteners 40 are inserted into the main block 10. Each fastener 40 has a thread screwed with one of the inner threads 120 in the main block 10, may be a bolt with a head, is mounted in one of the through holes 11 and is screw with a corresponding inner thread 120.

The pushing blocks 20 are attached respectively to the inclined surfaces 100 of the main block 10. Each pushing block 20 has a body 21, an inclined surface 210, an outer surface 211 and two resilient tongues 24. The body 21 has a top 22 and a bottom 23. The inclined surface 210 and the outer surface 211 are respectively formed at two sides of the body 21. The inclined surface 210 matches with and abuts with the inclined surface 100 on the main block 10. The resilient tongues 24 are formed on the body 21, and each resilient tongue 24 has a connecting end, a free end and an engaging protrusion 240. The connecting end is integrally connected with the body 21, and the free end is opposite to the connecting end. The engaging protrusion 240 is formed on and protrudes from the free end of the resilient tongue 24. When the engaging protrusion 240 is pressed, the free end of the resilient tongue 24 can move inward relative to the body 21. When the engaging protrusion 240 is released, the free end of the resilient tongue will move to an original position with the resilience of the resilient tongue 24. In the present embodiment, two recesses 241 are defined in the inclined surface 210, and the resilient tongues 24 are mounted respectively in the recesses 241. The connecting end of each resilient tongue 24 is connected integrally with one end of a corresponding one of the recesses 241. Each recess 241 has a space to allow the corresponding resilient tongue 24 to move inward relative to the body 21. In addition, each pushing block 20 has two flanges formed respectively the top 22 and the bottom 23 of the body 21, extending toward the main block 10 and abutting respectively with a top and a bottom of the main block 10.

The holding elements 30 are attached respectively to the outer surfaces 211 of the bodies 21 of the pushing blocks 20, and each holding element 30 has a body 31, two side flanges 32 and two engaging holes 33.

The side flanges 32 are formed respectively on two side edges of the body 31, extends toward and abut with a corresponding one of the pushing blocks 20 to limit the movement direction of the corresponding pushing block 20. The engaging holes 33 are defined through the body 31. The engaging protrusions 240 on the pushing blocks 20 extend respectively into the engaging holes 33. Each engaging protrusion 240 has a length larger than the thickness of the body 31, such that the engaging protrusions 240 protrude respectively out of the engaging holes 33. With the engagement of the engaging protrusions 240 and the engaging holes 33, the holding elements 30 are combined with the pushing blocks 20 firmly.

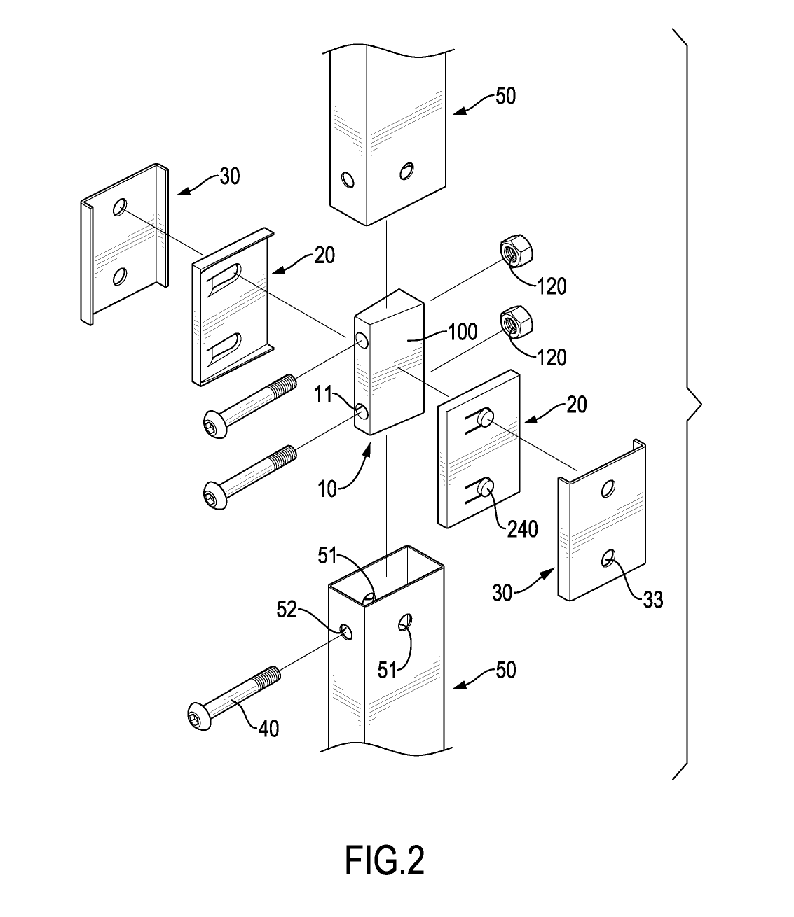

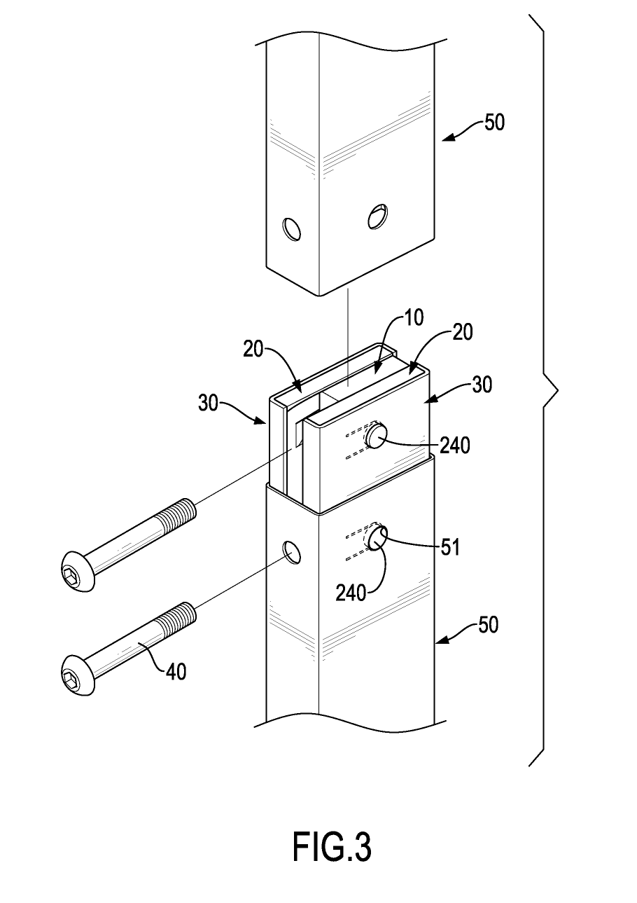

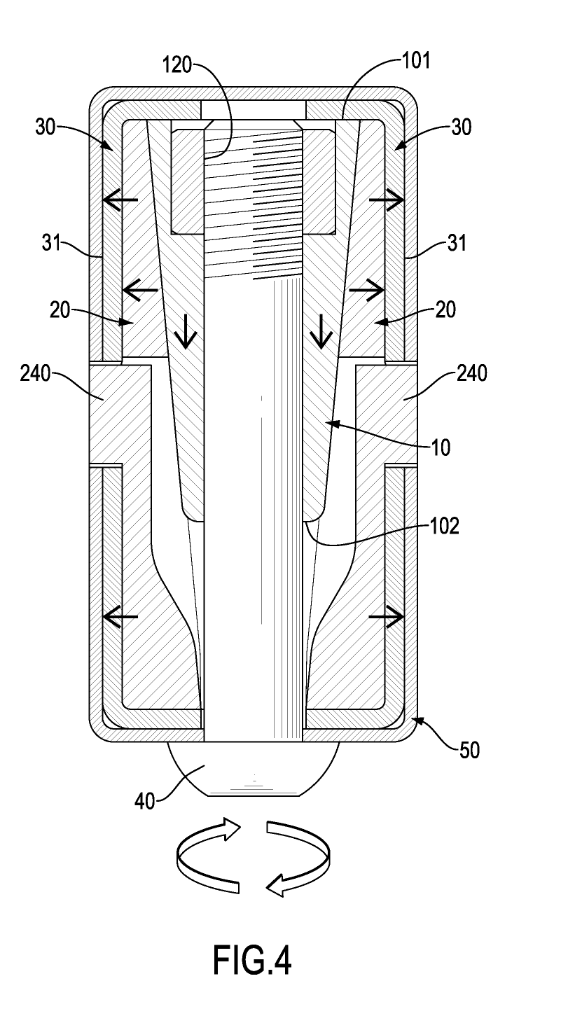

With reference to FIGS. 2 and 3, to connect two tubes 50 in rectangular cross section, and each tube 50 has a mounting hole 51 defined through two opposite sides of the tube 50 and a fattener hole 52 defined in another side of the tube 50. The pushing blocks 20 and the holding elements 30 are attached to the inclined surface 100 of the main block 10 to form as the connection device, and the engaging protrusions 240 on the pushing blocks 20 engaging into and protrude out of the engaging holes 33 in the holding elements 30. The connection device is inserted into an end of one of the tubes 50 in a half length of the connection device, such that the mounting hole 51 in the tube 50 engages two of the engaging protrusions 240 of the connection device. One fastener 40 is inserted into the fastener hole 52 in the tube 50 and is screwed with one of the inner threads 120 in the main block 10 to combine the tube 50 with the connection device. The other tube 50 is mounted around the connection device to make the mounting hole 51 in the tube 50 engage the other two of the engaging protrusions 240. The other fastener 40 is inserted into the fastener hole 52 in the tube 50 and is screwed with the other inner thread 120 in the main block 10, such that the tubes 50 can be connected with each other by the connection device. With reference to FIG. 4, the fasteners 40 are rotated until the heads of the fasteners 40 abut with the outer surface of the tubes 50. When the fatteners 40 are kept rotating, the main block 10 will be pushed to move along the axial direction of the fastener 40, such that the main block 10 is moved along the direction from the long side 101 to the short side 102. At this time, the inclined surface 100 of the main block 10 will push the pushing blocks 20 to move away from each other to push the holding elements 30 to abut against the inner wall of the tubes 50. Accordingly, the tubes 50 can be connected with each other firmly, and the combined tubes 50 can be applied to bear a large load.

To disconnect the tubes 50, the fasteners 40 are rotated in reverse. The main block 10 will move toward the long side 101 of the main block 10 to release the abutment of the holding elements 30 with the tubes 50. The engaging protrusions 240 are pressed via the mounting holes 51 in the tubes 50, and the tubes 50 can be detached from the connection device and from each other.

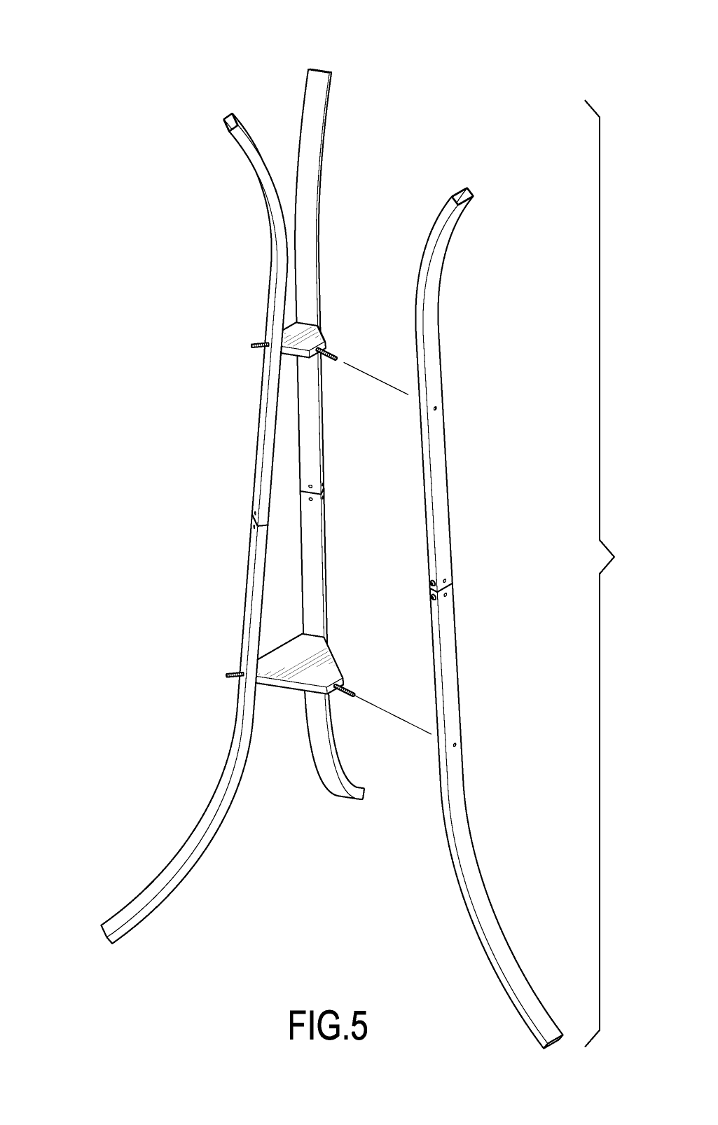

With reference to FIG. 5, the connection device in accordance with the present invention can be applied to connect tubes 50 of a coat stand, such that the coat stand can be assembled easily and stably.

Alternatively, the holding elements 30 can be omitted, and the pushing blocks 20 will be pushed to abut against the inner wall of the tubes 50 directly.

In the present embodiment, the fasteners 40 are inserted into the main block 10 from the short side 102. In an alternative embodiment, the fasteners 40 can be inserted into the main block 10 from the long side 101.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connection device for connecting tubes comprising:
a main block having a trapezoid cross section to form two inclined surfaces, a long side and a short side, two inner threads formed in the main block and extending to one of the long side and the short side;
two pushing blocks attached respectively to the inclined surfaces of the main block, and each pushing block having
a body;
an inclined surface and an outer surface respectively formed at two sides of the body; and
two resilient tongues formed on the body and each resilient tongue having a free end and an engaging protrusion formed on and protruding from the free end of the resilient tongue; and
two fasteners inserted into the main block and each having a thread screwed with one of the inner threads in the main block.

2. The connection device as claimed in claim 1, wherein each pushing block has two flanges formed respectively a top and a bottom of the body, extending toward the main block and abutting respectively with a top and a bottom of the main block.

3. The connection device as claimed in claim 2 further comprising
two holding elements attached respectively to the outer surfaces of the bodies of the pushing blocks, and each holding element having a body and two engaging holes defined through the body of the holding element, wherein
the engaging protrusions on the pushing blocks extend respectively into and protrude respectively out of the engaging holes in the holding elements.

4. The connection device as claimed in claim 3, wherein each holding element has two side flanges formed respectively on two side edges of the body of the holding element, extending toward a corresponding one of the pushing blocks to limit a movement direction of the corresponding pushing block.

5. The connection device as claimed in claim 4, wherein the main block having two through hole defined in the short side of the main block and communicating respectively with the inner threads.

6. The connection device as claimed in claim 5, wherein
the main block has two nut holes defined in the long side of the main block;
two nuts are mounted respectively in the nut holes; and
the inner threads are formed respectively in the nuts.

7. The connection device as claimed in claim 1 further comprising
two holding elements attached respectively to the outer surfaces of the bodies of the pushing blocks, and each holding element having a body and two engaging holes defined through the body of the holding element, wherein
the engaging protrusions on the pushing blocks extend respectively into and protrude respectively out of the engaging holes in the holding elements.

8. The connection device as claimed in claim 7, wherein each holding element has two side flanges formed respectively on two side edges of the body of the holding element, extending toward a corresponding one of the pushing blocks to limit a movement direction of the corresponding pushing block.

9. The connection device as claimed in claim 8, wherein the main block having two through hole defined in the short side of the main block and communicating respectively with the inner threads.

10. The connection device as claimed in claim 9, wherein
the main block has two nut holes defined in the long side of the main block;
two nuts are mounted respectively in the nut holes; and
the inner threads are formed respectively in the nuts.

11. The connection device as claimed in claim 1, wherein the main block having two through hole defined in the short side of the main block and communicating respectively with the inner threads.

12. The connection device as claimed in claim 11, wherein
the main block has two nut holes defined in the long side of the main block;
two nuts are mounted respectively in the nut holes; and
the inner threads are formed respectively in the nuts.

13. The connection device as claimed in claim 2, wherein the main block having two through hole defined in the short side of the main block and communicating respectively with the inner threads.

14. The connection device as claimed in claim 13, wherein
the main block has two nut holes defined in the long side of the main block;
two nuts are mounted respectively in the nut holes; and
the inner threads are formed respectively in the nuts.
